(19) United States
(12) Patent Application Publication
(10) Pub. No.: US 2021/0107378 A1
(43) Pub. Date: Apr. 15, 2021

(54) ACCUMULATOR ARRANGEMENT

(71) Applicant: Mahle International GmbH, Stuttgart (DE)

(72) Inventors: Stefan Hirsch, Stuttgart (DE); Michael Moser, Ellwangen (DE); Heiko Neff, Auenwald (DE); Mario Wallisch, Aichtal (DE)

(21) Appl. No.: 16/608,574

(22) PCT Filed: Apr. 17, 2018
(86) PCT No.: PCT/EP2018/059779

§ 371 Date: Oct. 25, 2019

(30) Foreign Application Priority Data
Apr. 26, 2017 (DE) 10 2017 206 985.6

(51) Int. Cl. B60L 58/26; B60K 1/04

(52) U.S. Cl. CPC B60L 58/26; B60K 1/04

(57) ABSTRACT

An accumulator arrangement for a motor vehicle may include an accumulator housing and at least one supply structure. The accumulator housing may include at least two parts and may define a receiving space for receiving a plurality of battery modules. The least one supply structure may be arranged in the receiving space and may be configured to supply at least two battery modules. The at least one supply structure may be arranged between two adjacent battery modules and operatively connected to each of the two adjacent battery modules. The at least one supply structure may include at least one duct through which a coolant is flowable to control a temperature of the two adjacent battery modules. The at least one supply structure may be assemblable and disassemblable via a movement in a Z-direction of the motor vehicle and may be coupled on the accumulator housing via a holding mechanism

### CROSS-REFERENCE TO RELATED APPLICATIONS

This application claims priority to International Patent Application No. PCT/EP2018/059779, filed on Apr. 17, 2018, and German Patent Application No. DE 10 2017 206 985.6, filed on Apr. 26, 2017, the contents of both of which are hereby incorporated by reference in their entirety.

### TECHNICAL FIELD

The present invention relates to an accumulator arrangement, in particular for a motor vehicle, comprising an at least two-part accumulator housing, which has a receiving space for receiving a plurality of battery modules, and comprising at least one supply device, which is arranged in or on the receiving space and which is provided for supplying at least two such battery modules.

### SUMMARY

In the case of today's electrically operated motor vehicles, so-called traction batteries are used to store electrical energy. The traction batteries are often formed from a plurality of battery modules, which are electrically interconnected with one another and which are arranged in an accumulator housing provided for this purpose, which is preferably sealed. These accumulator housings serve to protect the electronic system against external influences and usually consist of an upper housing shell and a lower housing shell. In general, such accumulator housings have a high demand in particular on tightness, due to the voltages of their individual battery modules, which are partially very high. An exchange of such battery modules currently represents a high assembly effort, because, generally speaking, the battery modules as such have to be removed together with the accumulator housing, in order to be able to open said accumulator housing in the first place.

A device for connecting at least two battery modules arranged in at least one row in a battery box of a vehicle, which battery modules adjoin one another with the interposition of a connecting plate, is well-known from DE 10 2012 012 891 A1. For this purpose, the connecting plate has centering elements, which protrude into corresponding centering openings of the two adjoining battery modules, on a module side. A connecting element, which is functionally uncoupled from the connecting plate and which connects the two adjoining battery modules on the opposite module side, is further provided in particular on the opposite module side. The battery box, formed from an upper shell and a lower shell, thereby plunges into a transmission tunnel of a vehicle underbody.

It is a disadvantage of the current prior art that for example the known supply structures are often not modular custom-made products, which, on the one hand, require an increased installation space requirement and, on the other hand, have the disadvantage that the fluidic and/or the electrical connections between the supply structure as such and the individual battery modules have to be inserted individually by hand, screwed or otherwise connected to one another in a complex manner, in response to the assembly.

### SUMMARY

The present invention thus deals with the object of specifying an improved or at least alternative embodiment for an accumulator arrangement of the above-mentioned type, which at least partially overcomes in particular the above-described disadvantages and which can additionally be produced in a cost-efficient manner by means of a simplified manufacture.

This object is solved according to the invention by means of the subject matter of the independent claim(s). Advantageous embodiments are the subject matter of the dependent claim(s).

The present invention is based on the general idea of arranging a supply device between two battery modules and to configure it in such a way that it is in an operative connection with the adjoining battery modules and has a duct, through which a coolant can flow, in order to control the temperature of the adjacent battery modules, in the case of an accumulator arrangement, in particular for a motor vehicle. For this purpose, the accumulator arrangement according to the invention has at least a two-part accumulator housing, which has a receiving space for receiving a plurality of battery modules, and at least one such supply device, which is arranged in or on the receiving space and which is provided for supplying at least two such battery modules. It is essential for invention thereby that the supply device is arranged between two such battery modules and is in each case in an operative connection therewith, and that the supply device has at least one such duct, through which a coolant can flow.

In an advantageous embodiment, the supply device is configured to be elongate and runs parallel to the longitudinal axis of the motor vehicle. The supply device thereby preferably forms a compact duct, which preferably runs parallel to the longitudinal axis of the motor vehicle, thus in the X-direction of the motor vehicle. Cross-members, which divide the receiving space into at least two areas and which provide the accumulator housing as such with a certain structural stiffness, can be provided in the receiving space of the accumulator housing. The cross-members thus extend in the Y-direction of the motor vehicle, which corresponds to a transverse axis of the motor vehicle. In the area of the supply device, the at least one cross-member has at least one aperture, which is provided for receiving exactly this one supply device. The at least one aperture on the cross-member weakens an important flexural stiffness of the cross-member only to a limited extent. It should be said that the supply device can be particularly reinforced in the area of the apertures of the cross-members. The reinforcement of the supply device can be attained, for example, by means of injection-molded metal inserts or, for example, by means of a construction-related stabilizing design in the vacant area.

In a further advantageous embodiment, the supply device extends across the entire length in the X-direction of the motor vehicle of the individual battery modules and is configured modularly on their respective longitudinal ends in the X-direction of the motor vehicle. The modular configuration is advantageous to the effect that in the case of a plurality of rows of battery modules, which are interrupted by means of cross-members, the supply devices can be attached to one another modularly in a simple manner and that the accumulator arrangement according to the invention can thus have different sizes.

A further advantageous embodiment provides that the supply device can be assembled and disassembled by means of a movement in the Z-direction of the motor vehicle. In particular in the case of repairs, service or maintenance of such traction batteries, this saves valuable time and thus also represents an advantage from a cost-related aspect.

In a further advantageous further development of the idea according to the invention, the supply device has at least one coolant inlet and at least one coolant outlet on a side facing a motor vehicle floor. This at least one coolant inlet and this at least one coolant outlet are preferably shaped cylindrically and are arranged so as to preferably not be offset or only slightly offset in the X-direction of the motor vehicle on a straight line, that is, in the Y-direction of the motor vehicle. In addition, the at least one coolant inlet and the at least one coolant outlet are preferably arranged at one height in the Z-direction of the motor vehicle, so that provided fluidic connections to the respective adjoining battery modules can be established simultaneously with an assembly of the battery modules or can likewise be disconnected in response to a disassembly of the battery modules, respectively, by means of a movement in the Z-direction of the motor vehicle.

In an advantageous embodiment, the supply structure has at least one forward flow duct and at least one return duct for the coolant. The division of the ducts in the interior of the supply device can generally be selected freely and is preferably configured in such a way that a homogeneous temperature control of the adjoining battery modules can take place in the best possible way.

A further advantageous embodiment provides that the supply device has electrical connection interfaces, which can be brought into contact with the respective adjacent battery modules. In addition to the electrical connection interfaces, further electronic components, such as, for example, CSC parts, BMS parts, fuses or gates can be arranged directly on the supply device. This is advantageous, because the electrical components can thus be cooled at least indirectly by means of the coolant, which flows through the at least one duct in the interior.

In a further advantageous embodiment, the supply device is held on the accumulator housing by means of a holding device. The holding device serves to protect the supply device from an unwanted loosening or from falling out of the accumulator housing.

In a further advantageous embodiment, the holding device is configured as a locking connection, which fixes the supply device to the accumulator housing, in particular in the Z-direction of the motor vehicle. A locking pin, which is supported on a support surface on the accumulator housing provided for this purpose and which thus tightly fixes the supply device, can for example be arranged on the supply device.

An advantageous further development provides that the supply device has positioning devices, each at least corresponding to the battery modules on both sides. The positioning devices can be configured, for example, as guide grooves comprising insertion bevels. The positionally accurate insertion of the battery modules makes it possible that for example fluidic connections and/or electrical connections and/or mechanical connections can be made possible between the supply device and the battery modules without further screwing, insertion or other assembly steps. The exact positioning between the supply device and the battery modules to one another thus provides for an optimal option for establishing the operative connections to one another.

In an advantageous embodiment alternative, the supply device is made of a plastic and is welded or adhered on its module interfaces. The production of the supply device of plastic can be realized in a particularly cost-efficient manner.

In a further advantageous embodiment alternative, the supply structure is made of a metal, preferably of aluminum, and is soldered, welded or adhered on its module interfaces.

A motor vehicle according to the invention comprising such an accumulator arrangement described above has the accumulator housing, wherein a motor vehicle underride protection is configured in one part or monolithically, respectively, with at least a portion of the at least two-part accumulator housing. The motor vehicle underride protection thus simultaneously represents the lower shell of the housing of the accumulator housing, so that an otherwise usual separate protective cover can be forgone completely.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows an isometric illustration of an accumulator arrangement according to the invention comprising a supply device arranged in a receiving space as well as a battery module adjacent thereto,

FIG. 2 shows the isometric illustration from FIG. 1 in an exemplary assembly state without battery modules,

FIG. 3 shows the isometric illustration from FIG. 1 in an exemplary assembly state comprising two battery modules, which are each arranged laterally on the supply device,

FIG. 4 shows an isometric detailed illustration of the supply device in an assembly state comprising a side panel, which is not arranged on one side,

FIG. 5 shows the isometric detailed illustration from FIG. 4 in an assembly state with laterally arranged side panel,

FIG. 6 shows an isometric detailed illustration of the supply device comprising a holding device arranged thereon as well as a positioning device arranged thereon,

FIG. 7 shows a top view from an underside of the motor vehicle onto the supply device according to the invention comprising adjacent battery modules,

FIG. 8 shows a top view from the top onto the supply device according to the invention comprising battery modules arranged on one side.

### DETAILED DESCRIPTION

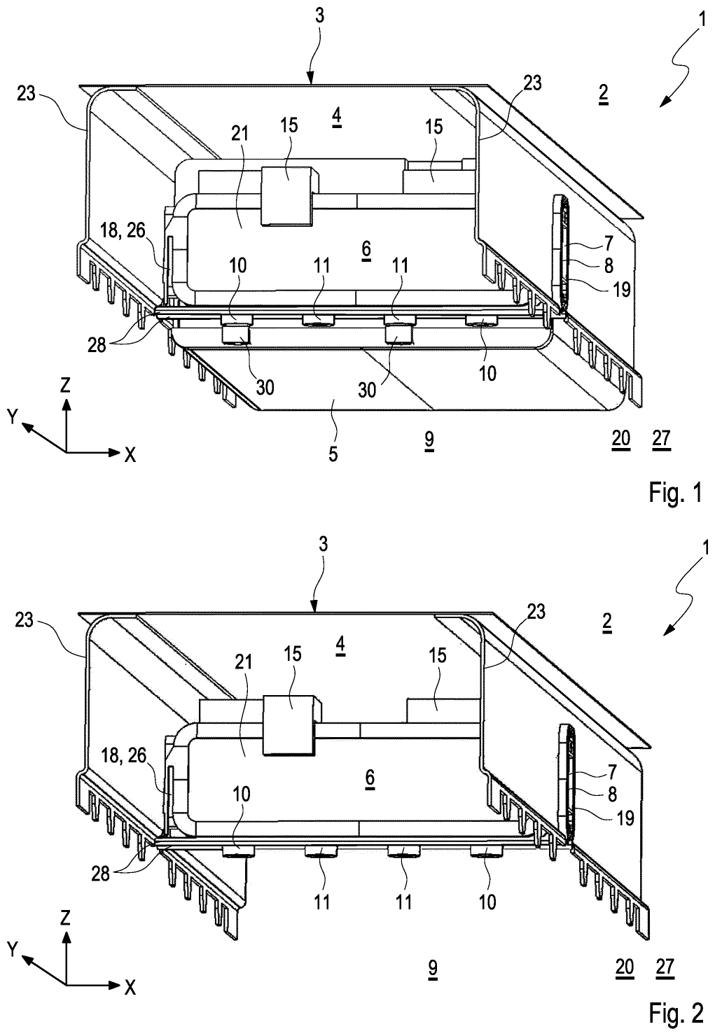

FIG. 1 shows an isometric illustration of an accumulator arrangement 1 according to the invention comprising a supply device 6 arranged in a receiving space 4, as well as a battery module 5 adjacent thereto. The accumulator arrangement 1 can be used in particular in a motor vehicle 2, which is otherwise not shown in more detail. The accumulator arrangement 1 according to the invention has at least one two-part accumulator housing 3, wherein the accumulator housing 3 can preferably be completely closed. The accumulator housing 3 can be closed, for example, by means of a lower housing shell 27, which is also not shown in the further figures. The lower housing shell 27 can thereby be configured in one part or monolithically, respectively, with a motor vehicle underride protection 20. The accumulator housing 3 essentially encloses the receiving space 4, which can be provided for receiving a plurality of such battery modules 5. In the X-direction of the motor vehicle, the shown receiving space 4 is defined by cross-members 23 arranged on both sides. The at least one supply device 6, which is provided for supplying at least two such battery modules 5, can likewise be arranged in or on the receiving space 4. In the shown exemplary embodiment, a battery module 5 has been forgone on one side for a better view onto the supply device 6. According to the invention, the supply device 6 can be arranged between two battery modules 5 and can in each case be in an operative connection therewith. The term operative connection can be understood, for example, as an electrical connection, a fluidic connection or a mechanical connection. The supply device 6 can be configured to be elongate and can run parallel to the longitudinal axis of the motor vehicle 2, thus in the X-direction of the motor vehicle. The supply device 6 can have at least one duct 7, through which a coolant 8 can flow.

It should be said that the illustrated accumulator arrangement 1 can be understood simply as a portion of a complete accumulator arrangement 1. This means that a plurality of “rows” of battery modules 5 can be provided, for example in the X-direction of the motor vehicle. The need for a supply device 6, which can be modularly expanded, as it is introduced in the context of this invention, can be derived therefrom. On the respective longitudinal ends thereof, the supply device 6 can thereby have module interfaces 19 in the X-direction of the motor vehicle, so that the supply device 6 can be expanded infinitely. It should further be noted that the accumulator arrangement 1 can also be expanded in the Y-direction of the motor vehicle, so that a plurality of supply devices 6, which are spaced apart in parallel in the Y-direction of the motor vehicle, can be provided.

The supply device 6 can be made of a plastic, whereby for example the bilateral side panels 21 can be adhered or welded to the supply device 6. Alternatively, the supply device 6 can also be made of a metal, preferably of aluminum, whereby the side panels 21 or a modularly attached second supply device 6 can be soldered, welded or adhered.

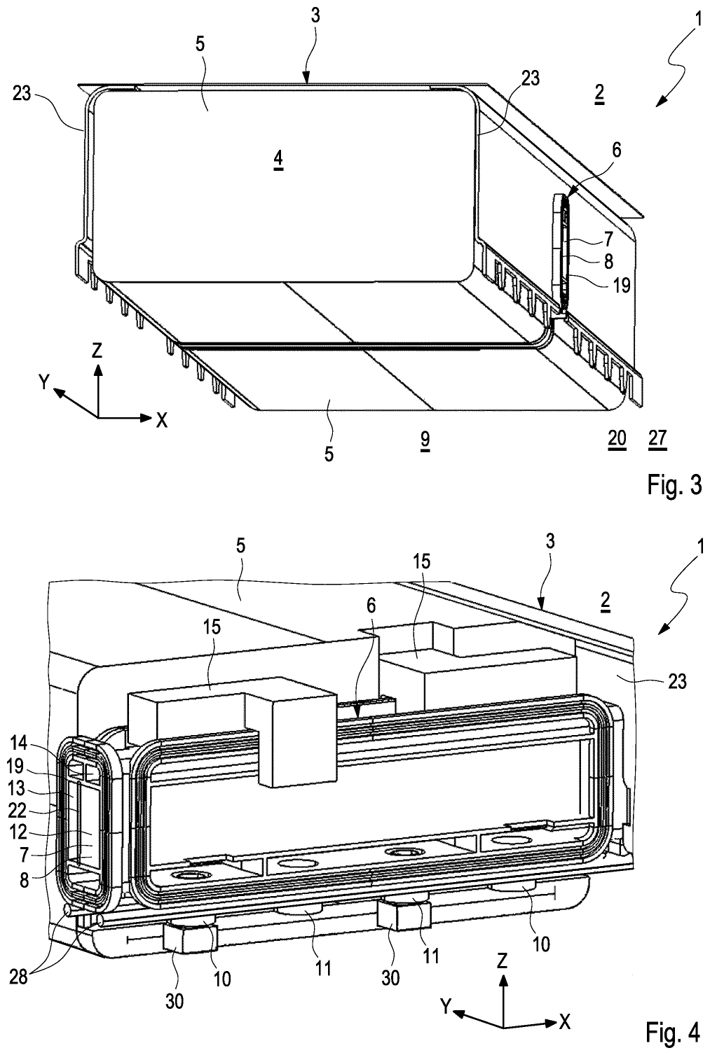

FIG. 2 and FIG. 3 show the isometric illustration from FIG. 1 in an exemplary assembly state without battery modules 5 as well as comprising two battery modules 5, which are each arranged laterally on the supply device 6. The supply device 6 can be assembled and disassembled into the receiving space 4 in the Z-direction of the motor vehicle.

FIG. 4 shows an isometric detailed illustration of the supply device 6 in an assembly state comprising a side panel 21, which is not arranged on one side, for better illustrating the fluidic connections of the coolant inlets 10 and of the coolant outlets 11. The supply device 6 can have at least one forward flow duct 12 and at least one return duct 13. The supply device 6, which is illustrated in an exemplary manner, has such a forward flow duct 12 and a first return duct 13 and a second return duct 14. Starting at the coolant inlet 10, a cross section of the forward flow duct 12 can taper. The cross section of the first return duct 13 can likewise widen or increase, respectively, parallel to the forward flow duct 12. The second return duct 14 can preferably be configured with a constant cross section. The forward flow duct 12 is separated from the first return duct 13 by means of a separating wall 22. To attain the above-described cross sectional tapering of the forward flow duct 12 and the cross sectional widening of the first return duct 13, the separating wall 22 can be arranged offset in the Y-direction of the motor vehicle. The measures, which change the cross section, can lead to a more even distribution of the coolant 8, which flows through the ducts 12, 13, whereby a more homogenous cooling of the individual battery modules 5 can be attained. The homogenous cooling can then be attained, when an amount of coolant 8, which is distributed as equally as possible, is released to non-illustrated branched-off temperature control units of the battery modules 5.

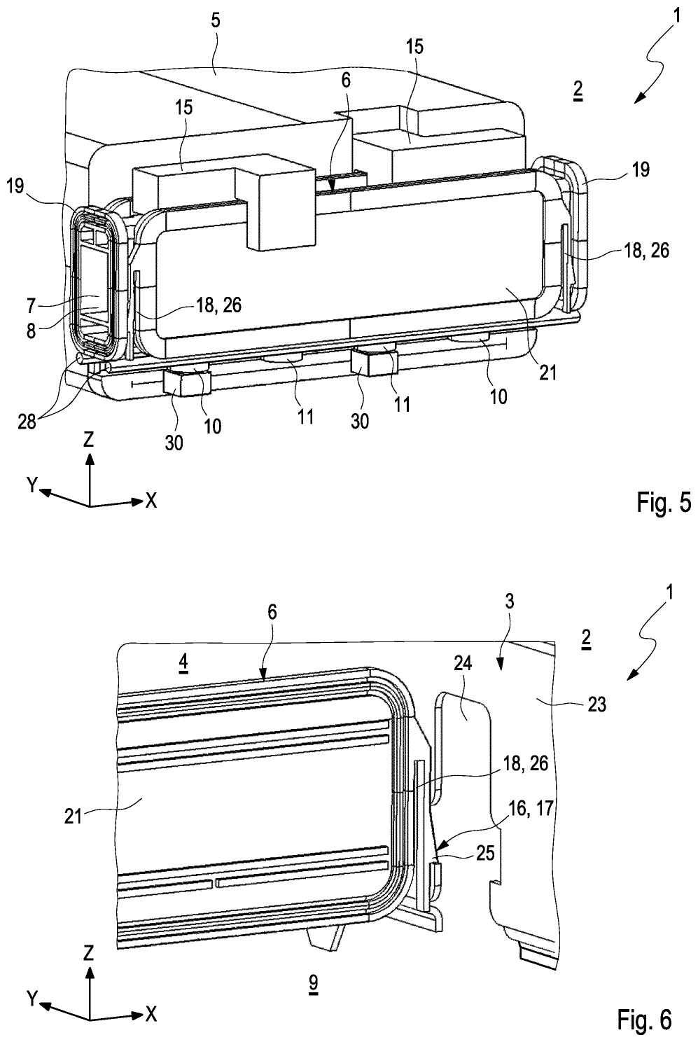

FIG. 5 shows the isometric detailed illustration from FIG. 4 in an assembly state comprising a laterally arranged side panel 21. The supply device 6 can additionally have electrical lines 28, which can be in electrical contact with electrical connection interfaces 15 and which preferably extend across the entire length of the supply device 6 in the X-direction of the motor vehicle.

FIG. 6 shows an isometric detailed illustration of the supply device 6 comprising a holding device 16 arranged thereon, as well as a positioning device 18 arranged thereon. The supply device 6 can be held on such a cross-member 23, which forms a part of the accumulator housing 3, in the area of an aperture 24 by means of the holding device 16. The holding device 16 can be configured as a locking connection 17 comprising a locking pin 25, which is at least partially supported on the cross-member 23. The locking connection 17 between the supply device 6 and the cross-member 23 or the accumulator housing 3, respectively, can provide for a fixation in the Z-direction of the motor vehicle. The positioning device 18 can be arranged on the bilaterally provided side panels 21 of the supply device 6. In the shown exemplary embodiment, the supply device 6 has, on its respective longitudinal sides, guide grooves 26 on both sides, comprising insertion bevels, which provide for a downstream positionally accurate insertion of the battery modules 5, which are not shown in this illustration.

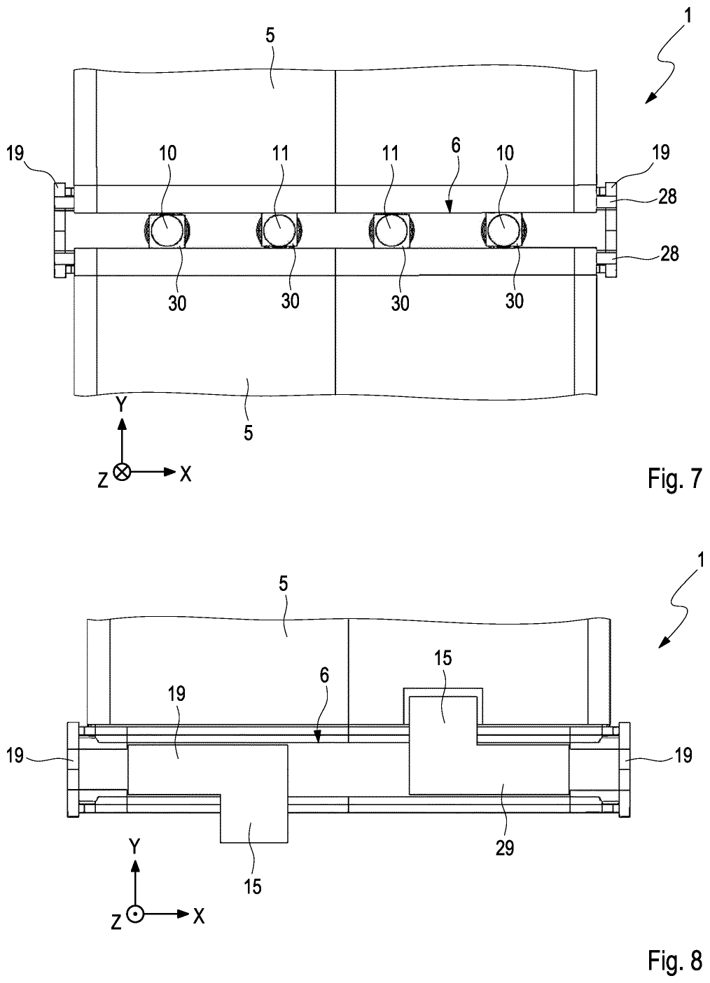

FIG. 7 shows a top view from below onto the supply device 6 according to the invention comprising adjacent battery modules 5. In the embodiment of the supply device 6, which is shown in an exemplary manner, two coolant inlets 10 and two coolant outlets 11 are arranged on a side facing the motor vehicle floor 9. The battery modules 5 arranged on the supply device 6 on both sides can in each case be fluidically connected to such a coolant inlet 10 and a coolant outlet 11 via fluid-guiding connecting elements 30, so that a coolant 8 can flow into a possibly provided cooling control structure in or on the respective battery modules 5 and can flow out again.

FIG. 8 shows a top view from the top onto the supply device 6 according to the invention comprising battery modules 5 arranged on one side. As can be gathered from the illustration, the supply device 6 can have such electrical connection interfaces 15, in each case facing the respective battery modules 5 on both sides. The electrical connection interfaces 15 can be brought into contact with the adjacent battery modules 5. The individual battery modules 5 of the accumulator arrangement 1 can thus be electrically interconnected with one another. Due to the advantageous embodiment of the accumulator arrangement 1, the electrical connection interfaces 15 can be brought into contact with the respective battery modules 5 by means of a movement of the battery modules 5 in the Z-direction of the motor vehicle. In response to the assembly of the battery modules 5, the electrical connections between the individual battery modules 5 can thus be established simultaneously without an additional assembly step. In addition to the electrical connection interfaces 15, further electronic components 29, such as, for example CSC parts, BMS parts, fuses or gates, can be arranged directly on the supply device 6.

1.-13. (canceled)

14. An accumulator arrangement for a motor vehicle, comprising:
an accumulator housing including at least two parts and defining a receiving space for receiving a plurality of battery modules;
at least one supply structure arranged in the receiving space, the at least one supply structure configured to supply at least two battery modules of the plurality of battery modules;
the at least one supply structure arranged between two adjacent battery modules of the plurality of battery modules and operatively connected to each of the two adjacent battery modules;
the at least one supply structure including at least one duct through which a coolant is flowable to control a temperature of the two adjacent battery modules;
wherein the at least one supply structure is assemblable and disassemblable via a movement in a Z-direction of the motor vehicle, and wherein the at least one supply structure is coupled on the accumulator housing via a holding mechanism.

15. The accumulator arrangement according to claim 14, wherein the at least one supply structure extends parallel to a longitudinal axis of the motor vehicle.

16. The accumulator arrangement according to claim 14, wherein the at least one supply structure extends across an entirety of a respective length, in a X-direction of the motor vehicle, of the plurality of battery modules, and wherein the at least one supply structure is configured modularly in the X-direction of the motor vehicle and is connected to a respective longitudinal end of the plurality of battery modules.

17. The accumulator arrangement according to claim 14, wherein the at least one supply structure includes at least one coolant inlet and at least one coolant outlet on a side facing a motor vehicle floor of the motor vehicle.

18. The accumulator arrangement according to claim 14, wherein the at least one supply structure includes at least one forward flow duct and at least one return duct through which the coolant is flowable.

19. The accumulator arrangement according to claim 14, wherein the at least one supply structure includes a plurality of electrical connection interfaces that are contactable to the two adjacent battery modules.

20. The accumulator arrangement according to claim 14, wherein the holding mechanism is configured as a locking connection securing the at least one supply structure to the accumulator housing.

21. The accumulator arrangement according to claim 14, wherein the at least one supply structure includes a plurality of positioning mechanisms corresponding to the two adjacent battery modules, and wherein the plurality of positioning mechanisms are disposed on both sides of the at least one supply structure.

22. The accumulator arrangement according to claim 14, wherein:
the at least one supply structure is composed of a plastic;
the at least one supply structure is configured modularly in a X-direction of the motor vehicle and includes a plurality of module interfaces; and
the plurality of module interfaces are at least one of welded and adhered to one another.

23. The accumulator arrangement according to claim 14, wherein:
the at least one supply structure is composed of a metal;
the at least one supply structure is configured modularly in a X-direction of the motor vehicle and includes a plurality of module interfaces; and
the plurality of module interfaces are at least one of soldered, welded, and adhered to one another.

24. A motor vehicle, comprising a motor vehicle underride protection and the accumulator arrangement according to claim 14, wherein at least a portion of the accumulator housing is (i) integrally provided as a single part with the motor vehicle underride protection and (ii) is structured monolithically with the motor vehicle underride protection.

25. The accumulator arrangement according to claim 14, wherein:
the at least one supply structure is configured modularly in a X-direction of the motor vehicle and includes a plurality of modules; and
each module of the plurality of modules includes at least one module interface via which the module is connected to an adjacent module of the plurality of modules.

26. The accumulator arrangement according to claim 14, wherein the at least one supply structure includes:
at least one coolant inlet and at least one coolant outlet on a side facing a motor vehicle floor;
at least one forward flow duct having a variable flow cross-section; and
at least one return duct having a variable flow cross-section.

27. The accumulator arrangement according to claim 26, wherein the flow cross-section of the at least one forward flow duct tapers in a direction away from the at least one coolant inlet.

28. The accumulator arrangement according to claim 27, wherein the flow cross-section of the at least one return duct increases in the direction away from the at least one coolant inlet in a complimentary manner to the taper of the at least one forward flow duct.

29. The accumulator arrangement according to claim 26, wherein:
the at least one forward flow duct and the at least one return duct are separated via a separating wall; and
the separating wall is offset in a Y-direction of the motor vehicle such that, in a complimentary manner, the flow cross-section of the at least one forward flow duct tapers in a direction away from the at least one coolant inlet and the flow cross-section of the at least one return duct increases in the direction away from the at least one coolant inlet.

30. The accumulator arrangement according to claim 14, wherein the at least one supply structure includes:
at least one coolant inlet and at least one coolant outlet on a side facing a motor vehicle floor;
at least one forward flow duct having a variable flow cross-section;
at least one first return duct having a variable flow cross-section; and
at least one second return duct having a constant flow cross-section.

31. The accumulator arrangement according to claim 14, wherein the at least one supply structure includes a plurality of positioning mechanisms configured as a plurality of guide grooves structured and arranged to facilitate accurate arrangement of the two adjacent battery modules.

32. An accumulator arrangement for a motor vehicle, comprising:
an accumulator housing including at least two parts and defining a receiving space for receiving a plurality of battery modules;
at least one supply structure configured to supply at least two battery modules of the plurality of battery modules, the at least one supply structure arranged in the receiving space and coupled to the accumulator housing via a holding mechanism;
the at least one supply structure arranged between two adjacent battery modules of the plurality of battery modules and operatively connected to each of the two adjacent battery modules;
the at least one supply structure including at least one duct through which a coolant is flowable to control a temperature of the two adjacent battery modules;
wherein the at least one supply structure is insertable into the receiving space in a Z-direction of the motor vehicle; and
wherein the at least one supply structure is configured modularly and includes a plurality of modules connected to one another in a X-direction of the motor vehicle via a plurality module interfaces.

33. An accumulator arrangement for a motor vehicle, comprising:
an accumulator housing including at least two parts and defining a receiving space for receiving a plurality of battery modules;
at least one modular supply structure configured to supply at least two battery modules of the plurality of battery modules, the at least one supply structure arranged in the receiving space and coupled to the accumulator housing via a holding mechanism;
the at least one supply structure arranged between two adjacent battery modules of the plurality of battery modules and operatively connected to each of the two adjacent battery modules;
the at least one supply structure including at least one forward flow duct and at least one return duct through which a coolant is flowable to control a temperature of the two adjacent battery modules; and
wherein the at least one supply structure is insertable into the receiving space in a Z-direction of the motor vehicle.
